(19) United States
(12) Patent Application Publication
(10) Pub. No.: US 2015/0331217 A1
(43) Pub. Date: Nov. 19, 2015

(54) PRE-LOADED FIBER RACEWAY SYSTEM

(71) Applicant: MULTILINK, INC., Elyria, OH (US)

(72) Inventor: Steven E. Kaplan, Elyria, OH (US)

(73) Assignee: MULTILINK, INC., Elyria, OH (US)

(21) Appl. No.: 14/277,262

(22) Filed: May 14, 2014

(51) Int. Cl. G02B 6/44

(52) U.S. Cl. CPC G02B 6/4459; G02B 6/4441

(57) ABSTRACT

A pre-loaded fiber raceway system for deploying optical fiber networks comprising an elongated substantially rigid base member having a back wall that is attachable to an interior wall structure of a building and a pre-loaded fiber flexible raceway tubing that is selectively routed and spliced into the base member. The length of the base member is interrupted at selected fiber drop points along the interior wall structure where the raceway tubing is unsupported by the base member. The raceway tubing has a split seam extending longitudinally along its length to permit the raceway tubing to be spread open along the split seam at the selected drop points for deploying one or more fibers from the raceway tubing at the selected drop points.

### FIELD OF THE INVENTION

This invention relates generally to a pre-loaded fiber raceway system for installation on interior wall structures of multi-dwelling units (MDUs) including but not limited to apartment buildings, hotels, hospitals, assisted living facilities, schools and the like.

### BACKGROUND OF THE INVENTION

It is generally known to use pre-loaded fiber raceway systems for prepositioning drop fibers in common hallways outside doors of each unit, apartment, room, etc. (hereafter collectively “unit”) of a MDU or the like to enable quick connections of optical fiber network cables to each unit that requests service. These cables can be used for different applications including, but not limited to, telecommunications, cable television, satellite, heating, ventilation and air conditioning, solar, fiber and coaxial/twisted pair applications and the like. However, there is an ongoing need for such a system that can be quickly deployed and routed around common hallway obstacles and the like to fiber drop points for each unit.

### SUMMARY OF THE INVENTION

The present invention relates to a pre-loaded fiber raceway system that includes a substantially rigid base member that can be installed on the wall of a common hallway with adhesive or mounting hardware and a pre-loaded fiber flexible raceway tubing that can be routed and spliced simultaneously into the base member.

In accordance with one aspect of the invention, the base member includes a generally U-shaped channel into which the pre-loaded fiber flexible raceway tubing is selectively routed and spliced/inserted.

In accordance with another aspect of the invention, the length of the base member is interrupted at selected fiber drop points along the length of an interior wall structure or the like where the raceway tubing is unsupported by the base member.

In accordance with another aspect of the invention, the raceway tubing has a split seam along its length to permit the raceway tubing to be spread open at selected fiber drop points for deploying one or more optical fibers within the raceway tubing at the selected fiber drop points.

In accordance with another aspect of the invention, the split seam in the raceway tubing is desirably oriented to face the back wall of the base member when supported thereby.

In accordance with another aspect of the invention, a plurality of elongated base members are selectively attachable to the interior wall structure in end to end spaced relation to one another at the selected fiber drop points, and a continuous length of the pre-loaded fiber raceway tubing extends within and between the plurality of elongated base members.

In accordance with another aspect of the invention, point of entry boxes are selectively attached to the interior wall structure at the fiber drop points for passage of the pre-loaded fiber raceway tubing into and through the boxes where a portion of the length of one or more of the fibers may be pulled out of the raceway tubing through the split seam and cut for installation in respective boxes.

In accordance with another aspect of the invention, one or more angled or tee fittings having opposite ends are selectively attachable to spaced apart ends of two or more angled base members for routing the pre-loaded fiber raceway tubing in any desired direction.

These and other objects, advantages, features and aspects of the present invention will become apparent as the following description proceeds.

### BRIEF DESCRIPTION OF THE DRAWINGS

In the annexed drawings:

FIG. 1 is a fragmentary perspective view of a pre-loaded fiber raceway system embodiment of the present invention comprising a base member and pre-loaded fiber raceway tubing routed and spliced simultaneously into the base member.

FIG. 2 is an enlarged transverse section through the raceway system of FIG. 1 taken on the plane of the line 2-2 thereof.

FIG. 3 is a schematic fragmentary plan view showing a length of the base member being installed on an interior wall structure of a building adjacent an inside vertical corner using an installation tool.

FIG. 4 is a schematic fragmentary plan view similar to FIG. 3 but showing the same installation tool being used to install another length of the base member on an interior wall structure adjacent an inside horizontal corner.

FIG. 5 is a transverse section through the installation tool of FIGS. 3 and 4.

FIG. 6 is a schematic fragmentary plan view similar to FIG. 4 but showing two horizontal base member lengths attached to the interior wall structure with ends in abutted engagement with opposite sides of a point of entry box mounted at a selected fiber drop point on the internal wall structure.

FIG. 7 is a schematic fragmentary plan view similar to FIG. 6 but showing the pre-loaded fiber raceway tubing inserted into the base members upstream of the point of entry box and extending into the box and beyond with a length of one of the fibers partially pulled out of the raceway tubing through the split seam in the area of the box for deploying the fiber at the selected drop point.

FIG. 8 is a schematic fragmentary plan view similar to FIG. 7 but showing the raceway tubing extending through the box and routed and spliced into the downstream base member and the partially pulled fiber stored inside the box and a flat elbow fitting snapped over the spaced apart adjacent ends of vertical and horizontal base members with the raceway tubing received in an arcuate channel within the elbow fitting.

FIG. 9 is an enlarged schematic transverse section through one end of the flat elbow fitting and associated end portion of the vertical base member onto which the elbow fitting is snap fitted in FIG. 8, taken on the plane of the line 9-9 thereof.

FIG. 10 is a schematic fragmentary perspective view showing different lengths of horizontal base members attached to an interior wall structure of a building adjacent 90° outside and inside corners of the wall structure and pre-loaded fiber raceway tubing routed and spliced within the base members and extending unsupported around the outside and inside corners.

FIG. 11 is a schematic fragmentary perspective view similar to FIG. 10 but showing outside and inside corner fittings snapped over spaced apart ends of adjacent horizontal base members at the corners and the pre-loaded fiber raceway tubing received in arcuate channels within the fittings.

FIG. 12 is an enlarged schematic fragmentary longitudinal section through the outside corner fitting and spaced apart ends of the adjacent horizontal base members of FIG. 11 onto which the outside corner fitting is snap fitted and the pre-loaded fiber raceway tubing therewithin, taken on the plane of the line 12-12 thereof.

FIG. 13 is an enlarged schematic fragmentary longitudinal section through the inside corner fitting and spaced apart ends of the adjacent base members of FIG. 11 onto which the inside corner fitting is snap fitted and the pre-loaded fiber raceway tubing therewithin, taken on the plane of the line 13-13 thereof.

### DETAILED DESCRIPTION

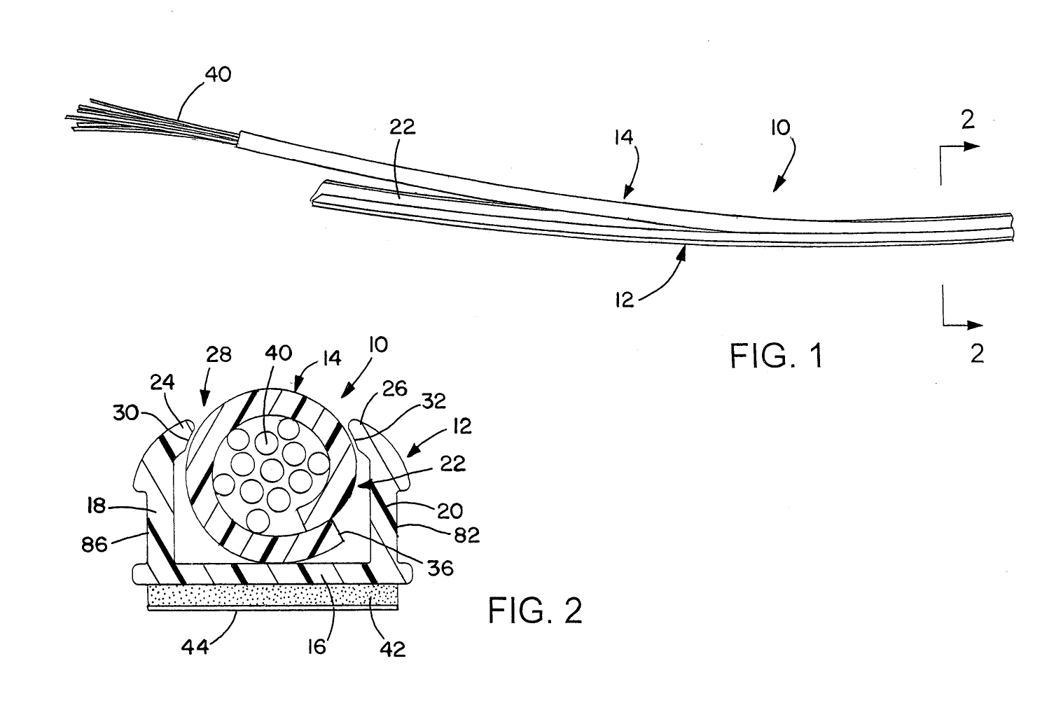

Referring now more particularly to the drawings, wherein the same reference numerals are used to designate like parts, and initially to FIGS. 1 and 2, there is shown one embodiment of a pre-loaded fiber raceway system 10 of the present invention comprising a base member 12 and a pre-loaded fiber flexible raceway tubing 14 being routed and spliced simultaneously into the base member.

The base member is desirably made of a suitable substantially rigid polymeric material, whereas the raceway tubing is made of a much more flexible polymeric material such as PVC and is pre-loaded with any desired number of bend insensitive optical fibers, for example, from one to twelve fibers. Because of the two-piece design, the base member can easily be installed on a variety of interior wall structure surfaces of a building using adhesive or mounting hardware and routed around common hallway obstacles or the like, after which the pre-loaded fiber raceway tubing can be routed and spliced simultaneously into the base member and accessories as described hereafter. Once installed, the raceway system, including the base member and raceway tubing and any accessories, can be painted any color desired using oil or latex base paint.

As best seen in FIG. 2, base member 12 comprises a substantially flat back wall 16 and laterally spaced apart outwardly extending side walls 18, 20 adjacent opposite side edges of the back wall defining a substantially U-shaped channel 22 for receipt of the pre-loaded fiber flexible raceway tubing 14 therewithin. The outwardly extending side walls 18, 20 of the base member 12 may have inturned outer edges 24, 26 defining a gap 28 therebetween of a width somewhat less than the outer diameter of the flexible raceway tubing 14 for removably retaining the flexible raceway tubing within the channel.

These inturned outer edges 24, 26 of the base member side walls 18, 20 may have inwardly angled inner surfaces 30, 32 facing each other to facilitate retention of the flexible raceway tubing within the channel. Also, the outer diameter of the flexible raceway tubing 14 is desirably somewhat greater than the height of the channel 22, whereby when the flexible raceway tubing is spliced/pressed into the channel, a portion of the flexible raceway tubing protrudes outwardly through the gap 28 beyond the outer edges 24, 26 of the channel side walls 18, 20 to provide a relatively close seal therebetween as shown in FIG. 2.

The flexible raceway tubing 14 desirably has a split seam 36 along its length that is oriented to generally face the back wall 16 of the base member 12 when spliced into the base member. The split seam not only permits the flexible raceway tubing to be spread open for ease of pre-loading any desired number of optical fibers 40 within the raceway tubing, but also permits the tubing to be spread open at selected fiber drop points for ease of deploying one or more fibers from the tubing at the selected drop points as described hereafter. FIG. 2 also shows an adhesive coating 42 applied to the back side of the base member back wall 16 and a removable release paper/tear sheet 44 overlying the adhesive layer. However, as previously indicated, the base member may be installed using mounting hardware instead of adhesive if desired.

The pre-loaded fiber raceway tubing 14 is desirably sufficiently flexible that it can be pre-loaded on spools of different lengths (e.g., 100, 200 or 300 feet lengths), but the base members are too rigid to be pre-loaded on spools, whereby the base members are provided in whatever lengths are desired or convenient.

During the installation process, any desired number of base members 12 may be attached to one or more interior wall structures of a building depending on the pathway and selected fiber drop points of the particular installation before the pre-loaded fiber raceway tubing is routed and spliced into the base member.

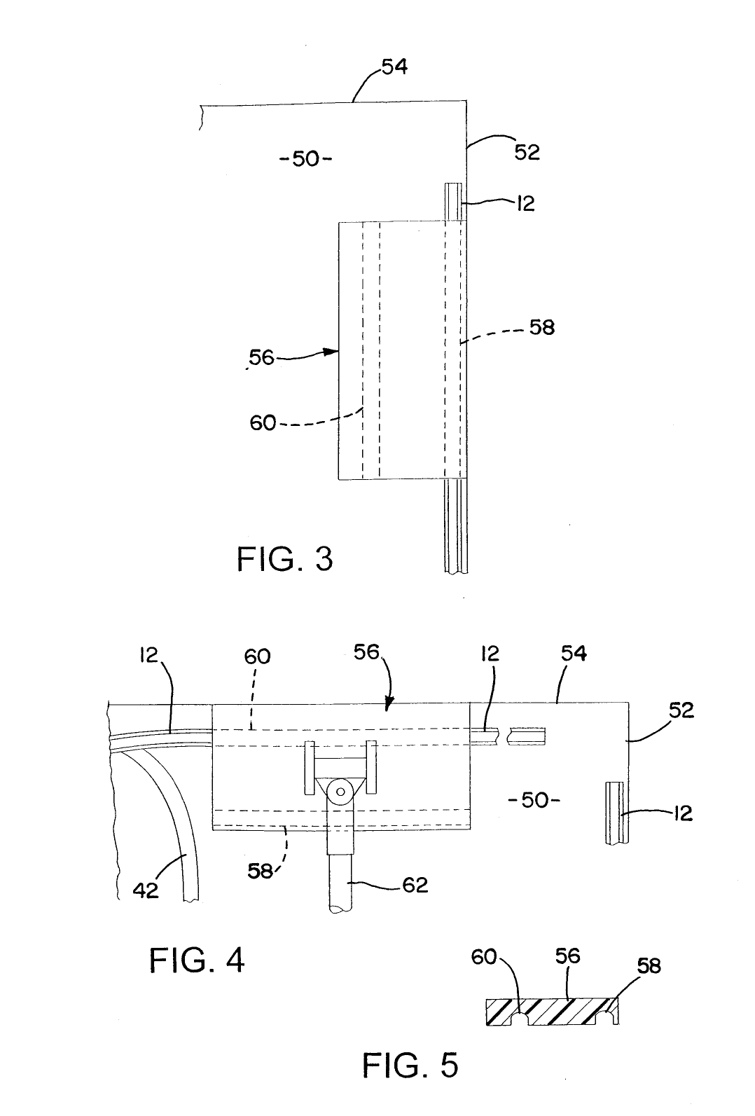

FIGS. 3 and 4 show different length base members 12 attached to an interior wall structure 50 adjacent vertical and horizontal corners 52, 54 of the wall structure. Also FIGS. 3 and 4 show an installation tool 56 that may but need not be used to facilitate installation of the base members in the desired spaced relation from an adjacent corner. Tool 56 includes one or more longitudinal notches 58, 60 sized and shaped for pressing the base members against the interior wall surface in the desired spaced relation from the inside corner of the wall, for example, approximately ⅛ inch from the vertical corner 52 and approximately ⅝ inch from the horizontal corner 54. The tool is designed to slide smoothly against the interior wall structure, and may be used by hand as shown in FIG. 3 or with a handle 62 as shown in FIG. 4. Also FIG. 4 shows the release paper 44 being removed from the adhesive backing 42 ahead of the tool pressing the base member 12 against the wall.

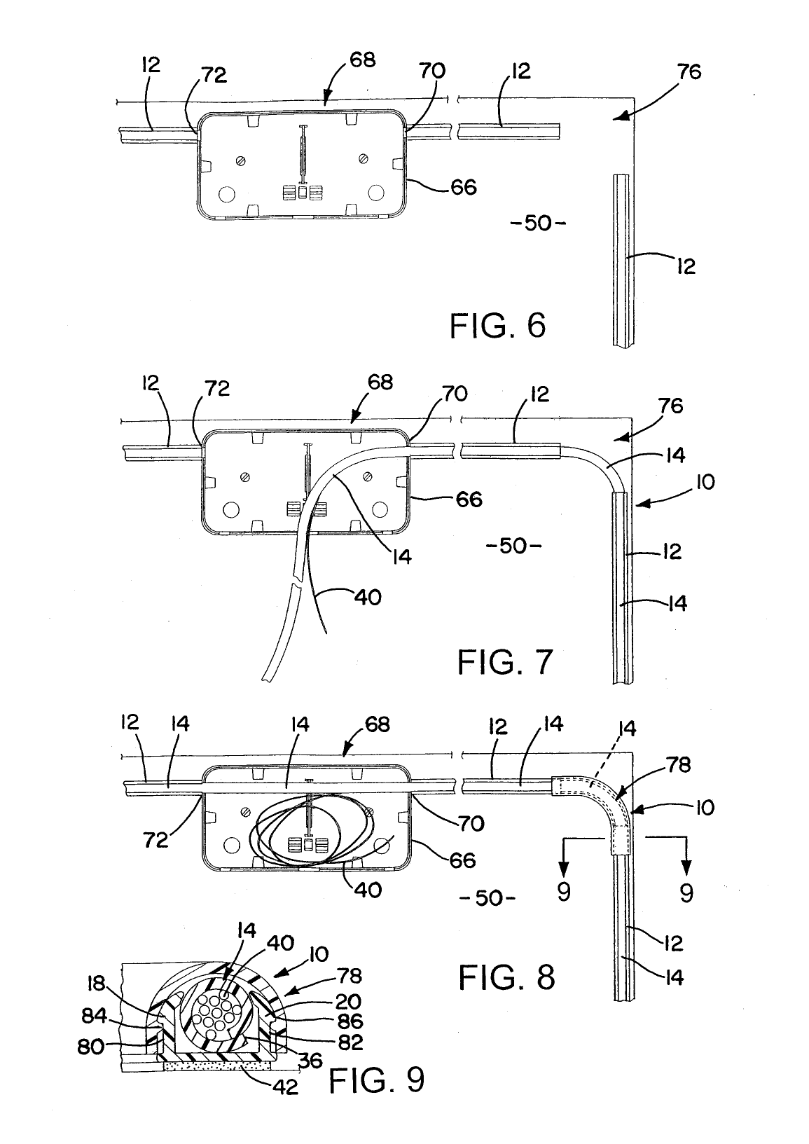

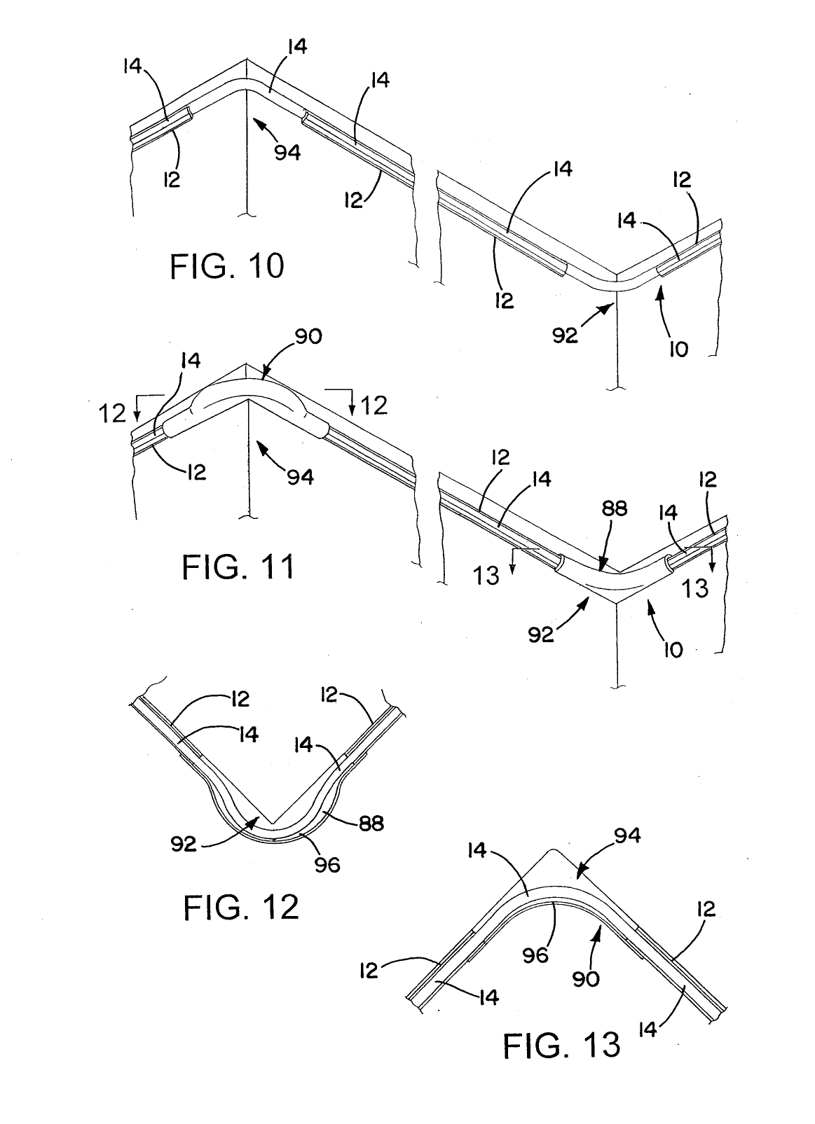

When approaching either inside or outside corners of a wall structure, the ends of adjacent base members are terminated an appropriate distance from the corners, for example, approximately 1¼ inches from an inside corner and approximately 2 inches from an outside corner, to allow for proper corner installation as described hereafter. Also the ends of the base members are terminated adjacent selected fiber drop points along the fiber pathway laid out on the interior wall structure in end to end spaced relation to one another to accommodate point of entry (POE) boxes that are attached to the interior wall structure at the drop points. One such POE box 66 is shown without its cover in FIGS. 6-8 attached to the interior wall structure 50 at a fiber drop point 68 with the spaced apart ends of two adjacent base members abutted against the box in alignment with selected slots 70, 72 therein.

Once the fiber pathway has been established by the installation of the base members 12 and point of entry boxes 66 and the fibers 40 at one end of a spool of pre-loaded fiber raceway tubing 14 have been connected to an appropriate fiber distribution terminal, the pre-loaded fiber raceway tubing is spooled off the spool as the tubing is routed and spliced into the base member channels 22, making sure that the split seam 36 of the raceway tubing is oriented to generally face the back wall 12 of the base members as schematically shown in FIGS. 2 and 9.

FIG. 7 shows the raceway tubing 14 routed along one or more vertical base members 12 and around an inside corner 76 and one or more horizontal base members for entry into one side of a POE box 66 through a slot 70 in a side wall thereof where a suitable length of one or more of the fibers 40 is pulled out of the raceway tubing through the split seam 36 and cut for installation within the POE box. Thereafter the routing of the raceway tubing is continued out through another slot 72 in the box and into another base member 12 in alignment therewith as schematically shown in FIG. 8. This process is repeated at each of the POE boxes in the particular installation.

The reason appropriate gaps are provided between the ends of adjacent base members 12 where the raceway system is routed in different directions is to accommodate angled fittings or tee fittings between such ends as needed. For example, FIGS. 8 and 9 show a flat elbow fitting 78 having opposite ends that are attachable to the spaced apart ends of two adjacent angled base members 12 as by providing outwardly facing longitudinal slots 80, 82 in the outer sides of the base member side walls 18, 20 and inwardly facing ribs 84, 86 on opposite sides of the fittings 78 that snap into the longitudinal slots when the fittings are inserted over the spaced apart ends of the base members as schematically shown in FIG. 9. Also FIGS. 11-13 show outside and inside corner fittings 88, 90 that are similarly snapped over the spaced apart ends of adjacent base members at outside and inside corners 92, 94 of the interior wall structure. In each case, the fittings have rounded channels 96 in which the pre-loaded fiber flexible raceway tubing 14 is received between the spaced apart ends of the base members to provide a protective cover for the raceway tubing at the corners. Similar seam covers (not shown) may be snap fitted over the adjacent ends of aligned base members for covering any gaps or seams therebetween.

Once the pre-loaded fiber raceway system 10 is completely installed, whenever a customer requests service, the fiber cable within the POE box for that particular unit can be quickly and easily connected to an optical network terminal within the customer's unit, in a manner well known in the art.

Although the invention has been shown and described with respect to certain embodiments, it is obvious that equivalent alterations and modifications will occur to others skilled in the art upon the reading and understanding of the specification. In particular, with regard to the various functions performed by the above-described components, the terms (including any reference to a “means”) used to describe the components are intended to correspond, unless otherwise indicated, to any component which performs the specified function of the described component (e.g., that is functionally equivalent), even though not structurally equivalent to the disclosed component which performs the function of the herein illustrated exemplary embodiments of the invention. In addition, while a particular feature of the invention may have been disclosed with respect to only one embodiment, such feature may be combined with one or more other features as may be desired or advantageous for any given or particular application.

What is claimed is:

1. A pre-loaded fiber raceway system for deploying optical fiber networks, the system comprising:
an elongated substantially rigid base member having a back wall attachable to an interior wall structure of a building and laterally spaced apart outwardly extending side walls adjacent opposite side edges of the back wall defining a substantially U-shaped channel; and
pre-loaded fiber flexible raceway tubing that is selectively routed and spliced into the channel,
wherein the outwardly extending side walls of the base member have inturned outer edges defining a gap therebetween of a width somewhat less than an outer diameter of the raceway tubing to allow the raceway tubing to be spliced into the channel for retaining the raceway tubing therewithin.

2. The system of claim 1 wherein the inturned outer edges of the side walls of the base member have inwardly angled inner surfaces facing each other to facilitate retention of the raceway tubing after insertion into the channel.

3. The system of claim 1 wherein the outer diameter of the raceway tubing is somewhat greater than a height of the channel, whereby when the raceway tubing is spliced into the channel, a portion of the raceway tubing protrudes outwardly through the gap beyond the outer edges of the channel side walls to provide a relatively close seal therebetween.

4. The system of claim 1 wherein the length of the base member is interrupted at selected drop points along the length of the interior wall structure where the raceway tubing is unsupported by the base member, and the raceway tubing has a split seam along its length to permit the raceway tubing to be spread open along the split seam at the selected drop points for deploying one or more fibers from the raceway tubing at the selected drop points.

5. The system of claim 4 wherein the split seam of the raceway tubing is oriented to generally face the back wall of the base member where supported by the base member.

6. The system of claim 4 wherein a plurality of elongated base members are attachable to the interior wall structure in end to end spaced relation to one another at the selected drop points along the interior wall structure.

7. The system of claim 6 wherein a continuous length of the raceway tubing extends within and between the plurality of elongated base members.

8. The system of claim 7 further comprising point of entry boxes attachable to the interior wall structure at the drop points for passage of the raceway tubing into the boxes where a portion of the length of one or more of the fibers is pulled out of the raceway tubing through the split seam and cut for installation of the one or more fibers in the boxes.

9. The system of claim 7 further comprising one or more angled fittings having opposite ends attachable to spaced apart ends of two or more adjacent angled base members for routing the raceway tubing in different directions.

10. The system of claim 9 wherein the opposite ends of the one or more angled fittings are snap fitted over the spaced apart ends of the adjacent angled base members.

11. The system of claim 8 wherein the angled fittings have rounded channels in which the raceway tubing is received between the spaced apart ends of the adjacent angled base members.

12. The system of claim 9 wherein outer sides of the side walls of the base members have outwardly facing longitudinal slots, and opposite sides of the angled fittings are flexible and have inwardly facing ribs that snap fit into the longitudinal slots when the fittings are inserted over the spaced apart ends of the adjacent angled base members.

13. The system of claim 1 wherein the back wall of the base member has an adhesive backing for adhesively attaching the base member to the interior wall structure.

14. A pre-loaded fiber raceway system for deploying optical fiber networks, the system comprising:
an elongated substantially rigid base member having a back wall that is attachable to an interior wall structure of a building and laterally spaced apart outwardly extending side walls adjacent opposite side edges of the back wall defining a substantially U-shaped channel; and
pre-loaded fiber flexible raceway tubing that is selectively routed and spliced into the channel,
wherein the length of the base member is interrupted at selected fiber drop points along the interior wall structure where the raceway tubing is unsupported by the base member, and the raceway tubing has a split seam extending longitudinally along its length to permit the raceway tubing to be spread open along the split seam at the selected drop points for deploying one or more fibers from the raceway tubing at the selected drop points.

15. The system of claim 14 wherein the split seam of the raceway tubing is oriented to generally face the back wall of the base member where supported by the base member.

16. The system of claim 14 wherein a plurality of elongated base members are attachable to the interior wall structure in end to end spaced relation to one another at the selected drop points along the interior wall structure.

17. The system of claim 16 wherein a continuous length of the raceway tubing extends within and between the plurality of elongated base members.

18. The system of claim 17 further comprising point of entry boxes attachable to the interior wall structure at the drop points for passage of the raceway tubing into the boxes where a portion of the length of one or more of the fibers are pulled out of the raceway tubing through the split seam and cut for installation of the one or more fibers in the boxes.

19. The system of claim 18 further comprising one or more angled fittings having opposite ends attachable to spaced apart ends of two or more angled base members for routing the raceway tubing in different directions, and wherein outer sides of the side walls of the base members have outwardly facing longitudinal slots, and opposite sides of the angled fittings are flexible and have inwardly facing ribs that snap fit into the longitudinal slots when the fittings are inserted over the spaced apart ends of the adjacent angled base members.

20. The system of claim 14 wherein the back wall of the base member has an adhesive backing for adhesively attaching the base member to the interior wall structure.
